(19) United States
(12) Patent Application Publication
(10) Pub. No.: US 2021/0379954 A1
(43) Pub. Date: Dec. 9, 2021

(54) METHOD AND APPARATUS FOR OPERATING SUSPENSION SYSTEMS

(71) Applicant: ClearMotion, Inc., Billerica, MA (US)

(72) Inventors: Lavern Michael Bremmer, Whitmore Lake, MI (US); Matthew Jo Taylor, Kenilworth, Warwickshire (GB); Zackary Martin Anderson, Cambridge, MA (US)

(21) Appl. No.: 17/285,280

(22) PCT Filed: Oct. 18, 2019
(86) PCT No.: PCT/US2019/057000

§ 371 Date: Apr. 14, 2021

Related U.S. Application Data
(60) Provisional application No. 62/747,805, filed on Oct. 19, 2018.

(51) Int. Cl. B60G 17/0165; B60G 17/0195

(52) U.S. Cl. CPC B60G 17/0165; B60C 23/04; B60G 17/0195

(57) ABSTRACT

The present disclosure discusses a method of operating a vehicle having a set of tires and an active suspension system. The method includes operating the vehicle to travel along a road surface, sensing, using a smart tire assembly, a magnitude of one or more physical quantities associated with at least one tire of the set of tires, and controlling the active suspension system of the vehicle based at least in part on the magnitude of the sensed one or more physical quantities.

### FIELD

Disclosed embodiments are related to suspension systems including dampers and suspension actuators and their control for mitigating the effects of road surface discontinuities.

### BACKGROUND

The suspension system of a vehicle is intended to at least partially shield the occupants from road-induced disturbances and to mitigate the effects of travel related accelerations such as in the lateral, longitudinal and vertical directions. Active suspension systems for a vehicle overcome some of the known trade-offs associated with conventional passive suspension systems.

### SUMMARY

In some embodiments, a vehicle may include a smart tire assembly where the assembly includes a tire and one or more sensors integrated with the tire. The one or more sensors may be configured to sense a magnitude of one or more physical quantities (e.g., air pressure of the tire, contact patch area and/or shape, contact forces (e.g., longitudinal, lateral, and vertical (normal) loads) associated with the tire, slippage (e.g., longitudinal slippage, slip ratio, and/or slide slip angle), tread depth, adhesion characteristics of the road (e.g., road roughness, friction coefficient)). The vehicle may also include an active suspension system with an actuator (e.g., a hydraulic actuator, an electric actuator, an electro mechanical actuator) and a controller configured to control the actuator (e.g., configured to control a force exerted by the actuator, configured to control a length of the actuator). In this embodiment the controller may be in communication (e.g., electrical communication, wireless communication) with the one or more sensors. Furthermore, the one or more sensors may be configured to generate an output (e.g., an electrical voltage, an electric current, an optical signal, an electromagnetic signal) that corresponds to the magnitude of the sensed one or more physical quantities. The controller may be configured to receive the output and to generate a command parameter (e.g., a command force, a command torque, a command current, a command position/length) based at least in part on the received output.

In some embodiments a smart tire assembly of a vehicle may include a tire and one or more sensors configured to sense a magnitude of one or more physical quantities (e.g., air pressure of the tire, contact patch area and/or shape, contact forces (e.g., longitudinal, lateral, and vertical (normal) loads) acting on the tire, slippage (e.g., longitudinal slippage and/or slide slip angle), tread depth, adhesion characteristics of the road (e.g., road roughness, friction coefficient)). The vehicle may also include an active suspension system with an actuator (e.g., a hydraulic actuator, an electric actuator, an electro mechanical actuator) and a controller configured to control the actuator (e.g., configured to control a force exerted by the actuator, configured to control a length of the actuator). The controller of the active suspension system of the vehicle of the embodiment may be in communication with the one or more sensors of the smart tire assembly.

In some embodiments, a vehicle may include a smart tire assembly and an active suspension system. In this embodiment the smart tire assembly may include one or more sensors that, while the vehicle is traveling along a road surface, senses a magnitude of one or more physical quantities associated with at least one tire or set of tires of the vehicle (e.g., air pressure of the tire, contact patch area and/or shape, contact forces (e.g., longitudinal, lateral, and vertical (normal) loads) acting on the tire, slippage (e.g., longitudinal slippage and/or slide slip angle), tread depth, adhesion characteristics of the road (e.g., road roughness, friction coefficient)). A controller may be used to control the active suspension system of the vehicle based at least in part on the magnitude of the sensed one or more physical quantities. According to one aspect, the present specification discloses a vehicle including a smart tire assembly. The smart tire assembly includes a tire and one or more sensors integrated with the tire, wherein the one or more sensors are configured to sense a magnitude of one or more physical quantities of the tire. The vehicle also includes an active suspension system. The active suspension system includes an actuator and a controller configured to control the actuator, wherein the controller is in communication with the one or more sensors integrated with the tire.

In some implementations, the one or more sensors integrated with the tire are configured to generate an output that corresponds to the magnitude of the sensed one or more physical quantities, and the controller is configured to receive the output and to generate a command parameter based at least in part on the received output. In some instances, the output comprises at least one of an electrical voltage, an electric current, an optical signal, and an electromagnetic signal.

In some implementations, the one or more physical quantities of the tire comprises at least one of air pressure of the tire, tire contact patch area and/or shape, contact forces acting on the tire, slippage, tread depth, and adhesion characteristics of the road.

In some implementations, the controller is configured to control a force exerted by the actuator or configured to control a length of the actuator.

In some implementations, the command parameter is a command force, a command torque, a command current, or a command position/length.

According to another aspect, the present specification discloses a method including affixing a smart tire assembly to a vehicle, wherein the smart tire assembly includes a tire and one or more sensors configured to sense a magnitude of one or more physical quantities. The method also includes installing an active suspension system into the vehicle, wherein the active suspension system includes an actuator and a controller configured to control the actuator. The method also includes placing the controller of the active suspension system in communication with the one or more sensors of the smart tire assembly.

In some implementations, the one or more sensors integrated with the tire are configured to generate an output that corresponds to the magnitude of the sensed one or more physical quantities, and the controller is configured to receive the output and to generate a command parameter based at least in part on the received output.

In some implementations, the one or more physical quantities of the tire comprises at least one of air pressure of the tire, tire contact patch area and/or shape, contact forces acting on the tire, slippage, tread depth, and adhesion characteristics of the road. In some instances, the controller is configured to control a force exerted by the actuator or configured to control a length of the actuator.

In some implementations, the command parameter is a command force, a command torque, a command current, or a command position/length.

According to another aspect, the present specification discloses method of operating a vehicle having a set of tires and an active suspension system. The method includes operating the vehicle to travel along a road surface. The method also includes sensing, using a smart tire assembly, a magnitude of one or more physical quantities associated with at least one tire of the set of tires. The method also includes controlling the active suspension system of the vehicle based at least in part on the magnitude of the sensed one or more physical quantities.

In some implementations, the one or more physical quantities of the tire includes at least one of air pressure of the tire, tire contact patch area and/or shape, contact forces acting on the tire, slippage, tread depth, and adhesion characteristics of the road.

In some implementations, controlling the active suspension system includes controlling a vertical force exerted by an actuator of the active suspension system.

In some implementations, the actuator is a hydraulic actuator.

In some implementations, the method also includes generating, via one or more sensors integrated into the smart tire assembly, an output, and receiving, by a controller of the active suspension system, the output.

In some implementations the output is an electrical voltage, an electric current, an optical signal, or an electromagnetic signal.

In some implementations the method also includes determining, by the controller of the active suspension system, a command parameter based at least in part on the received output, wherein the command parameter is a command force, a command torque, a command current, or a command position/length.

In some implementations, the command parameter is a command force, and the method further includes operating an actuator of the active suspension system to apply the command force to a body of the vehicle and/or a wheel or wheel assembly of the vehicle.

In some implementations, operating the actuator to apply the command force includes determining, based on the command force, a command torque. Operating the actuator to apply the command force also includes operating an electric motor to apply the command torque to a rotor of a pump of the actuator.

It should be appreciated that the foregoing concepts, and additional concepts discussed below, may be arranged in any suitable combination, as the present disclosure is not limited in this respect. It should be further understood, that the disclosure is not limited to the precise arrangements, variants, structures, features, embodiments, aspects, methods, advantages, improvements, and instrumentalities shown and/or described. Additionally, the various arrangements, variants, structures, features, embodiment, aspects, methods, and instrumentalities may be used singularly in the system or method or may be used in combination with other arrangements, variants, structures, features, embodiment, aspects, methods, and instrumentalities. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

FIG. 1 illustrates an embodiment of a vehicle that includes a smart tire in communication with an active suspension system controller.

FIG. 2 schematic illustration of a portion of an exemplary vehicle with active suspension.

### DETAILED DESCRIPTION

A vehicle traveling along a road surface may undergo displacement and/or acceleration in the vertical direction due to changes in elevation, discontinuities, bumps or depressions in the road surface. In addition, vehicles may undergo fore-aft acceleration (e.g. due to braking and/or changes in speed) or lateral acceleration (e.g. due to turning). Acceleration of a vehicle in any direction ultimately must rely on the application of one or more forces at the vehicle/road interface, i.e. the vehicle tires. In the absence of such forces a vehicle could not accelerate in any direction in the absolute reference frame.

Traditionally, active suspension systems have been used to mitigate the impact of road or inertially induced disturbances in order to improve passenger comfort and vehicle handling. On the other hand, passive systems need to resort to a trade-off between comfort and handling. Various aspects of exemplary active suspension systems and components thereof are described in U.S. Pat. No. 10,040,330, the contents of which are incorporated by reference herein in their entirety.

In an exemplary active suspension system, one or more actuators (e.g. one at each corner of a vehicle) may be used to actively raise or lower a sprung mass (e.g. the body or chassis) of the vehicle relative to an unsprung mass (e.g. a wheel or wheel assembly) of the vehicle. Various control systems may be used. For example, a “skyhook” control system may be designed to minimize absolute vertical movement of the body (e.g., yielding a ‘smooth’ ride to increase occupant comfort), regardless of road conditions or features, such as, bumps and potholes. Conversely, a “groundhook” control system may be designed to minimize relative vertical movement of the body of the vehicle relative to the ground or road surface (therefore allowing an occupant of the vehicle to more clearly “feel connected” to the road with better actual and/or perceived handling).

In an exemplary control system of an active suspension system, a set of one or more sensor outputs may be received by a controller. The controller may execute a particular scheme (e.g., groundhook control, skyhook control, or a combination thereof) to determine one or more actuator commands. The sensor outputs may correspond, for example, to acceleration of the vehicle body, acceleration of a wheel or a wheel assembly, degree of extension and/or compression of an actuator of the active suspension system, a spring force exerted by a spring of the active suspension system. The actuator command(s) may correspond to, for example, a command force (e.g., a linear force or a torque), a command position, or any other appropriate command parameter. For example, in a skyhook control system, an acceleration sensor (e.g., an accelerometer) may be utilized to determine acceleration of the vehicle body. The output of the acceleration sensor may be provided to the controller, and the controller may determine a command force based at least in part on the output of the acceleration sensor. The controller may then command the actuator of the active suspension system to apply the commanded force to a component of the vehicle.

Controllers may be used to control the operation of an active suspension (or semi-active) system to control the motion of the sprung mass and/or an unsprung mass of a vehicle in the absolute reference frame. These controllers may receive signals from a variety of sensors that may be, for example, connected to a sprung mass and/or an unsprung mass of a vehicle. These sensors may react to various types of input, such as for example, displacement or acceleration of a component of the vehicle. Alternatively or additionally, these sensors may react to various types of actuator input.

Because of their location, the input to these sensors may be influenced by the intervening compliance or damping between the sensors and forces at the road/tire interface. For example, the inputs to sensors located on the sprung or unsprung mass of a vehicle may produce a signal that is attenuated and/or out of phase with the force or forces that may be present at the road/tire interface.

Inventors have recognized that using sensors that may be embedded in or otherwise incorporated with a tire of a vehicle, such as those in “smart tires” or “intelligent tires” may significantly improve the effective response of semi-active and active suspension systems. As described herein, locating one or more sensors at or in a tire of a vehicle (at or near the road/tire interface) may yield more accurate, faster, and/or more complete description of, for example, the forces and/or accelerations at the road/tire interface than may be obtained by sensors located on the sprung mass and/or on other more distal (from the tire/road interface) portions of the unsprung mass.

The terms “smart tire” and “intelligent tire” are used interchangeably herein to refer to tire assemblies that are capable of collecting information about one or more physical quantities associated with a tire or tire component (e.g. tire wall, tire tread) and/or the tire/road interface. Such physical quantities may include, for example, tire air pressure, contact patch area and/or shape, contact forces (e.g., longitudinal, lateral, and vertical (normal) contact forces), slippage (e.g., longitudinal slip and/or side slip angle), tread depth, local or average stress, local or average strain, speed, and/or displacement of the tire and/or adhesion characteristics of the road (e.g., road roughness, friction coefficient). Smart tires may include one or more “smart tire sensors.” As used herein, “smart tire sensors” are sensors that are located in a tire and/or attached to or embedded in any portion of the tire and capable of collecting information about such physical quantities.

The inventors have further recognized the benefit of using one or more smart tire sensors to collect data for controlling the operation of an active suspension system. Particularly, such tire based sensors may detect and report more reliably and accurately the magnitude of a physical quantity related to the interaction between the tire and the road surface. The sensed quantity may be an input into a controller that controls the active suspension system or one of the actuators of the system.

For example, a smart tire sensor may sense a vertical contact reaction force imparted to the tire by the road surface. A controller may receive the output from the smart tire, and may control one or more components (e.g., actuators, motors, pumps, etc.) of an active suspension system based on the received sensor data. The controller, for example, may determine a set of one or more command parameters based on this information. In various embodiments, the set of one or more command parameters may include: a command force (e.g., a force desired from the actuator), a command torque (e.g., a torque to be applied by an electric motor of the active suspension system), a command current (e.g., a current to be applied to an electric motor of the active suspension system), or a command position (e.g., a desired position or length of an actuator). In some embodiments, a component of the active suspension system may then apply the set of one or more command parameters (e.g., the actuator may apply the command force to the body of the vehicle or the wheel assembly, the electric motor may apply the command torque, an actuator may retract or extend to reach the command position, etc.).

In an exemplary condition, a vehicle may travel over a road surface having a depression such as, for example, a pothole. The pothole may have a dimension such that only one wheel of the car traverses the pothole at any given time. When a tire of the vehicle begins to traverse the pothole, the tire may, at least momentarily, lose contact with the road surface. At that instant, the vertical contact reaction force may drop to zero or effectively to zero. A contact force substantially equal to zero, or a sudden drop in vertical contact force, may therefore be used to determine exact time when a tire of the vehicle encounters a pothole or becomes airborne. In some embodiments and/or under certain conditions, it may be desirable for the car to follow the road, for example to maximize perceived or actual handling. Under such conditions, the active suspension system may be controlled to, for example, push the tire down into the pothole in order to increase the vertical contact force (e.g., an actuator of the active suspension system may be commanded to apply a downward force on a wheel or wheel assembly of the vehicle and an upward force on the body of the vehicle). Alternatively, a pothole handling strategy may be implemented to minimize the penetration of the tire into the pothole wheel is traversing the pothole. A pothole strategy may include applying a force at one or more corners of vehicle to enable the tire interacting with the pothole to “jump” over it.

Alternatively or additionally, in certain embodiments, information collected by a smart tire may be used to more effectively (e.g. accurately and/or quickly compared to sensors located on the sprung mass or portions of the unsprung mass other than the tire) detect and/or identify road surface characteristics such as, for example, road roughness, road discontinuity (e.g. pot hole or bump), or road cover (e.g. snow, water, ice, and/or oil). Based on the determined road surface characteristics, one or more control parameters (e.g., gain values, weights, or other parameters used in the control system) may be modified. For example, for a road surface with substantial roughness, it may be desirable to soften the suspension response in order to at least partially mitigate the effects on “secondary ride” (e.g., the transfer of energy from roughness in the road surface to the vehicle body). Alternatively or additionally, in certain embodiments information collected by a smart tire may be used more effectively to determine friction between the tire and the road surface and/or a coefficient of friction. The active suspension system may be controlled based at least in part on the determined friction and/or coefficient of friction (e.g., if the coefficient of friction may be low and braking may be requested, the active suspension system may apply a downward force on a wheel of the vehicle in order to increase traction).

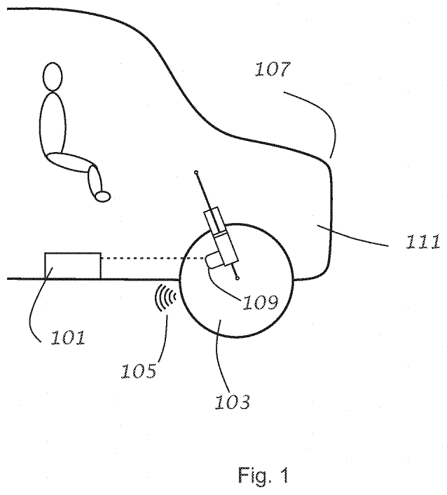

FIG. 1 illustrates a portion of an exemplary vehicle 107 that includes both a smart tire assembly 103 and an active suspension system including one or more actuators 109. The smart tire assembly 103 includes one or more sensors capable of sensing the magnitude of one or more physical quantities associated with the tire, the road surface and/or the interaction between the tire and the road surface. Sensed physical quantities may include one or more of air pressure of the tire, contact patch area and/or shape, contact forces (e.g., longitudinal, lateral, and vertical (normal) loads), slippage (e.g., longitudinal slippage and/or slide slip angle), tread depth, and/or adhesion characteristics of the road (e.g., road roughness, friction coefficient). One or more smart tire sensors may be in communication with a first controller 101 of the active suspension system. In certain embodiments, the communication may be via electrical communication. In certain embodiments the communication may be wireless, according to techniques known in the art. In certain embodiments, the smart tire may communicate with the first controller 101 of the active suspension system via any number of intermediary components (e.g., the smart tire may be in communication with a central vehicle controller, which in turn may be in communication with the first controller of the active suspension system). In certain embodiments, the first controller 101 of the active suspension system may be integrated into a central vehicle controller, and/or may include a plurality of distributed processors. In certain embodiments the first controller may be integral to an active suspension actuator. In some embodiments, information from one or more smart tire sensors may be shared or exchanged between one or more controllers over various communication channels such as a CAN bus or wireless transmitter/receiver combinations. Alternatively or additionally, a controller receiving smart tire sensor data may apply sensor fusion techniques using data from other sensors received directly or indirectly from other sensors.

In the illustrated embodiment, the smart tire assembly 103 generates an output 105 (e.g., an electromagnetic signal) based on the magnitude of the sensed one or more physical quantities. In the illustrated embodiment, the first controller 101 of the active suspension system may be configured to receive the output 105 from the smart tire. In an exemplary embodiment, the first controller 101 of the active suspension system may be configured to determine a first command parameter based on the received output 105. In certain embodiments, the first command parameter may be a command force, and the controller may be configured to control an actuator 109 of the active suspension system to apply the command force to a body 111 of the vehicle and/or to a wheel or wheel assembly of the vehicle. In certain embodiments, the active suspension system may further include a second controller (not pictured) in communication with the first controller. The second controller may receive the first command parameter and may determine a second command parameter based on the first command parameter. For example, the second controller may convert a command force into a command torque, wherein the command torque corresponds to a torque that, when applied to a pump of the actuator (e.g., by an electric motor), results in the actuator applying the command force. Alternatively, the second controller may convert a command force into a command current, wherein the command current corresponds to an electrical current that, when applied to a motor of the actuator, results in the actuator applying the command force.

In certain embodiments, the first controller 101 may be remotely located relative to a wheel of the vehicle, and the second controller may be located locally relative to the wheel of the vehicle. In certain embodiments, the first controller 101 and second controller may be integrated into a single hardware unit or set of units (e.g., a single processor or a set of distributed processors), and may correspond to different software modules executed on the hardware unit or set of units. The second controller may be optional, and in certain embodiments the first controller 101 may directly control the active suspension system or actuator 109 thereof without the need for a second controller.

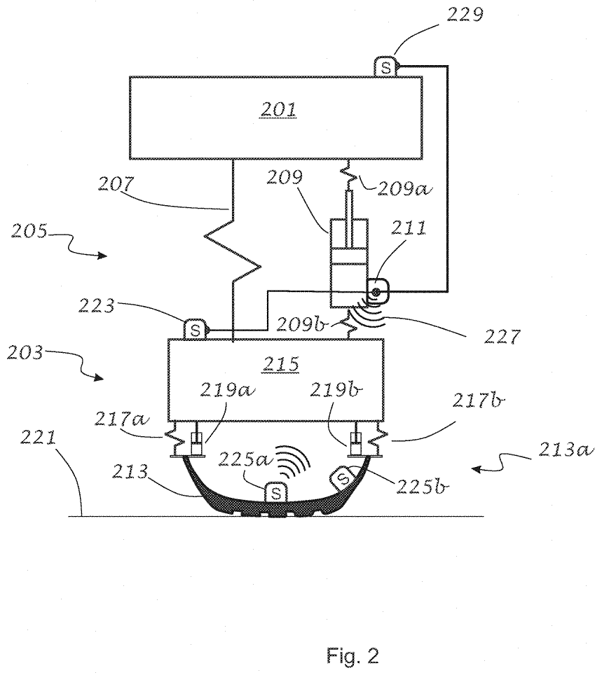

FIG. 2 illustrates a schematic of a portion of an exemplary vehicle. The exemplary vehicle may include a sprung mass 201 (that may include, for example, a vehicle body and top mount 209a) and an unsprung mass 203 (that may include, for example, a tire 213, a wheel, wheel assembly, a spring seat, and/or a brake assembly). The unsprung mass 201 and sprung mass 203 may be physically and movably coupled by a suspension system 205. In some embodiments, the suspension system 205 is an active suspension system and may include a spring element 207 (e.g., a coil spring and/or an air spring) and an actuator 209 arranged between a portion of the sprung mass and the unsprung mass. The actuator 209 may be controlled by an active suspension system controller 211. In other embodiments, the suspension system 205 may be a semi-active suspension system and may include the spring element and a variable controllable damper arranged between a portion of the sprung mass 201 and the unsprung mass 203.

The unsprung mass 203 may include a rotatable portion (that may include, for example, the tire 213, wheel, and/or wheel hub) and a static portion 215 (that may include, for example, the spring seat, bushing 209a and/or break assembly (not shown)). The rotatable portion of the unsprung mass 203 may include a tire 213 that may be constructed of an elastomeric material. As is known in the art, the tire 213 may provide compliance (represented schematically as a set of spring elements 217a-b in FIG. 2) and/or damping elements (represented schematically by a set of damping elements 219a-b in FIG. 2). When the vehicle is moving, the rotatable portion of the unsprung mass 203, including the tire 213, may rotate relative to the sprung mass and the static portion 215 of the unsprung mass 203. If the tire 213 of the vehicle encounters a feature of a road surface 221 (for example, a bump or a depression), kinetic energy may be imparted into the tire 213. This kinetic energy may initially result in vertical motion of the rotatable portion of the unsprung mass 203 and/or in compression or deformation of a portion of the tire 213. The vertical motion energy may be transferred through the spring and/or damper elements of the tire 213 and into the static portion 215 of the unsprung mass 203, resulting in vertical displacement or motion of the static potion 215 of the unsprung mass 203. Vertical motion of the static portion 215 of the unsprung mass 203 may, in turn, be transferred through the suspension system 205 and into the sprung mass 201, resulting in vertical displacement or motion of the sprung mass 201.

To evaluate the effect of a road surface feature 221 on vertical motion of the sprung mass 201 of the vehicle, a series of transfer functions may be considered. A tire model (which describes tire dynamics) may describe how displacements in the road surface are transferred from the road surface, through the spring-damper system of the tire 213, and into the static portion 215 of the unsprung mass 203. The tire model may be highly non-linear and may depend on a variety of quantities including, for example, tire pressure, rotational wheel speed, vehicle speed, angular position of the tire, slip ratio, tire strain (including shear strain and normal strain), etc. A suspension transfer function may describe how vertical displacements or motion of the static portion 215 of the unsprung mass 203 are transferred from the static potion 215 of the unsprung mass 203, through the suspension system 205, and into the sprung mass 201. An active suspension system may be utilized to dynamically vary the transfer function, e.g., by varying damping in the suspension system or by actively imparting forces using the actuator of the suspension system.

Active suspension systems may be controlled based on one or more sensors 223 (e.g., accelerometers and or inertial motion units (IMU)) mounted to the static portion 215 of the unsprung mass 203. Due to the aforementioned tire dynamics, however, vertical displacement/motion of the static portion 215 of the unsprung mass 203 may not effectively reflect vertical displacements of a road surface 221. For example, due to the tire dynamics, there may be a time delay between the moment the tire 213 encounters the road surface feature 221 (e.g., a bump or pothole) and a resulting vertical displacement or motion of the static portion 215 of the unsprung mass 203. Likewise, due to, for example, compliance of the tire 213, there may be non-linear variation in magnitude between the dimension of the road surface feature 221 and a resulting displacement of the static portion 215 of the unsprung mass 203. Therefore, sensors mounted on the static portion 215 of the unsprung mass 203 and configured to detect vertical displacement/motion of the static portion of the unsprung mass may not properly account for tire dynamics and may give only an indirect and/or delayed measurement of road surface displacements encountered by the tire 213. In these cases, a tire model may be used to estimate an appropriate tire transfer function in order to correlate the measured vertical displacement/motion of the static portion 215 of the unsprung mass 203 with displacements in the road surface. Likewise, a tire model may be used to correlate forces imparted onto the static portion 215 of the unsprung mass 203 by the actuator of the active suspension with forces at the tire/road surface interface. However, given the highly non-linear and complex nature of tire dynamics, such models may be complex and difficult to implement with accuracy.

The inventors have recognized that a more direct, accurate, and/or effective measure of vehicle/road surface interactions may be obtained by utilizing a smart tire assembly 213a that includes one or more sensors 225a-b mounted in and/or proximate to the tire itself and/or configured to detect physical quantities associated with the tire itself and/or the tire/road interface. In certain embodiments a smart tire assembly may include a set of strain sensors distributed within the tire 213 and/or the tire wall and that is configured to detect strain at one or more locations in the tire 213. The strain of the tire 213 may be directly correlated to forces at the tire/road surface 221 interface. For example, when the tire encounters a bump in the road surface, the tire 213 may be compressed, resulting in an increase in normal strain measured in the tire 213. U.S. Pat. No. 9,815,343, the contents of which are incorporated herein by reference in their entirety, discloses various tire sensors, such as strain sensors, which can be used to measure strain at one or more locations in a tire. In certain embodiments, smart tire sensors may be used to reduce system latency and to achieve better ground hook or sky hook control of vehicle motion compared to controllers that rely exclusively on sensors attached to the sprung and/or unsprung masses. For example, in some applications a wheel controller may be used to reduce contact patch force by using smart tire sensors that directly obtain information about, for example, strain at one or more locations of the tire, acceleration of one or more points on the tire, contact patch size, slip angle, etc. Reduced latency resulting from at least partial reliance on smart tire sensors may also be used to improve body control by collecting more direct information about road events such as traversing bumps and potholes. For example, the use of data relating to slip angle and normal load at the tire may be used to estimate yaw disturbance induced due to, for example, active control of the vehicle body by the body controller. This estimation may enable a controller to switch control methods (i.e., from a sky hook control strategy to a ground hook control strategy) or maintain a sky hook-based control method if no undesired yaw disturbance is predicted.

In some implementations, data from smart tire sensors may be used as inputs to a road estimation algorithm or system. In some instances, the data may relate to normal load fluctuation at the contact patch of the tire. For example, normal load fluctuation detection can help prevent inadvertent force commands from being sent to the active suspension actuator in response to road events which may introduce errors into the system (e.g., “skipping” a pothole because of driving at high speed). In another example, the normal load fluctuation detection may allow the active suspension system to adjust the actuators to reduce normal load fluctuation. This may allow increased confidence in outputs from the road estimation algorithm as tire oscillation is minimized. In some instances, the data may relate to longitudinal slip at the tire. Understanding longitudinal slip at the tire may allow increased precision of position estimation by a localization algorithm interacting with the road estimation algorithm. For example, if the tire is slipping, it is not rolling and may not be located at an originally estimated position. In some instances, the data may relate to tire pressure and normal load fluctuation. Receiving such data as inputs allows the road estimation algorithm to compute an estimation of tire deflection/tire spring rate. The estimation of tire deflection/tire spring rate may enable more accurate road estimation by allowing the actuators of the active suspension system to be adjusted by the controller in view of the tire spring rate to reduce normal load fluctuation on the tire. This may allow increased confidence in outputs from the road estimation algorithm as tire oscillation is minimized. Exemplary embodiments of road estimation algorithms and localization algorithms are shown and described in U.S. Patent Application Publication No. 2019/0079539, the entirety of which is hereby incorporated by reference.

In certain embodiments, the one or more sensors 225a-b of the smart tire assembly may be in communication with the controller 211 of the active suspension system. In certain embodiments, the communication may occur via a wireless electromagnetic signal 227. In some embodiments, the communication may include one or more cables. In some embodiments, one or more smart tire sensors may be powered wirelessly, by for example, electromagnetic radiation. In certain embodiments, the active suspension system controller 211 may be configured to control an actuator 209 of the active suspension system in response to variations in normal strain of the tire 213 as measured by one or more sensors of the smart tire assembly. In some embodiments, the active suspension system may be controlled to maintain a substantially constant normal strain of the tire. In the example of the tire encountering a bump in the road surface, the normal strain in the tire may increase as the tire is compressed; in response to this increase, the active suspension system may actively apply an upward vertical force on the unsprung mass in order to unload the tire and restore its previous level of strain. In this way, energy imparted into the tire may be precluded from reaching the vehicle body, resulting in an improved ride experience.

In another embodiment, the active suspension system controller may be in communication with the smart tire assembly and one or more sensors 223 (e.g., accelerometers, displacement sensors, IMUs) mounted to the static portion of the unsprung mass and/or one or more sensors 229 (e.g., accelerometers, displacement sensors, IMUs) mounted to the sprung mass. In certain embodiments, the active suspension system controller may have access to a tire model. The tire model may, for example, take the form of a look-up table. The tire model may describe the tire transfer function as a function of one or more tire parameters, including one or more of: angular position of the wheel, wheel speed, strain ratio, normal strain, normal force, contact patch characteristics, and/or tire pressure. The one or more tire parameters may be determined and communicated to the active suspension system controller by the smart tire assembly. The active suspension system controller 211 may be configured to control the actuator 209 of the active suspension system 205 based on information received from the smart tire assembly and input from the one or more sensors mounted to the static potion of the unsprung mass and/or the one or more sensors mounted to the sprung mass.

In certain embodiments, the smart tire assembly may include a first set of one or more sensors configured to determine air pressure within the tire, and a second set of one or more sensors configured to determine a size and/or shape of a contact patch of the tire. Based on the size of the contact patch and the air pressure within the tire, an estimate of the vertical force acting on the tire may be obtained. In certain embodiments, the active suspension system controller may be configured to control an actuator of the active suspension system based on the estimated vertical force acting on the tire of the vehicle and/or a desired change in the magnitude of the vertical force from a first level to a second higher or lower level. As discussed previously, determining the vertical force using sensors directly at the tire may account for complex tire dynamics, thereby yielding a more direct and accurate determination of vertical force at a given time than may be obtained by using sensors located on other parts of the unsprung mass or the sprung mass.

In certain embodiments, the smart tire assembly may include one or more tread depth sensors that are configured to determine a tread depth of the tire. In certain embodiments, the active suspension system controller may be configured to control the actuator of the active suspension system based on the determined tread depth. For example, if the tread depth is determined to be below a threshold depth, then the tire may not be able to achieve sufficient traction for handling maneuvers (e.g., braking or steering maneuvers). In certain embodiments, the active suspension system or active stability system of the vehicle may compensate for poor traction (e.g., caused by insufficient tread depth) in a given tire by preferentially loading the other tires of a vehicle to increase traction force of the other tires.

Alternatively or additionally, smart tire sensors may be used to collect detailed information of road surface for mapping purposes. Inventors have recognized that exclusively using sensors mounted on a sprung mass (e.g. vehicle body) or other portions of an unsprung mass besides the tire (e.g. the wheel assembly) may not yield a sufficient level of data fidelity desirable for producing digital maps. In some embodiments, smart tire sensors may be used to collect high fidelity data for use in producing digital maps. Furthermore, in some embodiments high fidelity smart tire sensor data may be collected and compared to previously collected data for localization of a vehicle. The contents of U.S. patent application entitled “Road Surface Based Vehicle Control,” Ser. No. 16/130,311 filed on Sep. 13, 2017, that describe systems and methods for determining the location of a vehicle based at least partly on road surface information, are incorporated herein by reference in their entirety.

The sensors of the smart tire assembly may sense physical quantities associated with the tire and/or the road surface using a variety of techniques. In certain embodiments, a set of one or more accelerometers may be integrated into the tire. In certain embodiments, the smart tire may include a force sensor (e.g., a capacitive force sensor) integrated into the tire. In certain embodiments, the smart tire may include a plurality of fibers distributed within the tire and/or on an outer surface of the tire. In these embodiments, the smart tire may sense the relative deflection of a portion of the plurality the fibers in order to determine the magnitude of one or more physical quantities associated with the tire and/or road surface. In certain embodiments, the smart tire may include a plurality of piezo-electric components distributed around the tire that allows for determining deformation of the tire. In certain embodiments, the smart tire assembly may include a set strain gauges that are uniformly or non-uniformly distributed throughout the tire. For examples of smart tires, see, e.g.: Cole, D .J. and Cebon, D., 1989, A capacitive strip sensor for measuring dynamic type forces. Proc. of the Second International Conference on Road Traffic Monitoring, London, 38-42; Cole, D. J. and Cebon, D., 1992, Performance and application of a capacitive strip tyre force sensor. Proc of IEEE Conference on Road Traffic Monitoring, London, 123-132. Yi, J., 2008. A piezo-sensor-based “smart tire” system for mobile robots and vehicles. IEEE/ASME transactions on ntechatronics, 13(1), pp.95-103. Pasterkamp, W. R. and Pacejka, H. B., 1997, The tire as a sensor to estimate friction. Vehicle System Dynamics, 27, 409-422; Pohl, A., Steindl, R. and Reindl, L., 1999, The ‘intelligent tire’ utilizing passive SAW sensors measurement of tire friction. IEEE Transactions on Instrumentation and Measurement, 48(6), 1041-1046; Ray, L. R., 1997, Nonlinear tire force estimation and road friction identification: Simulation and experiments. Automatics, 33(10), 1819-1833 Braghin, F., Brusarosco, M., Cheli, F., Cigad A., Manzoni, S., & Mancosu, F. (2006). Measurement of contact forces and contact patch features by means of accelerometers fixed inside the tire to improve future car active control. Vehicle System Dynamics, 44(sup I), 3-13.

As used herein, a “controller” is understood to mean one or more integrated circuits (such as, for example, a processor), along with associated circuitry and/or software, that collectively are configured to receive an input, determine a command signal based on the input, and communicate and/or apply the command signal to a target component. It is understood that multiple controllers may share one or more hardware components. For example, multiple controllers may be implemented as distinct software modules that are executed on a single processor.

1. A vehicle comprising:
a smart tire assembly comprising:
a tire; and
one or more sensors integrated with the tire,
wherein the one or more sensors are configured to sense a magnitude of one or more physical quantities of the tire; and
an active suspension system comprising:
an actuator; and
a controller configured to control the actuator,
wherein the controller is in communication with the one or more sensors integrated with the tire.

2. The vehicle of claim 1, wherein the one or more sensors integrated with the tire are configured to generate an output that corresponds to the magnitude of the sensed one or more physical quantities, and wherein controller is configured to receive the output and to generate a command parameter based at least in part on the received output.

3. The vehicle of claim 2, wherein the output comprises at least one of an electrical voltage, an electric current, an optical signal, and an electromagnetic signal.

4. The vehicle of claim 1, wherein the one or more physical quantities of the tire comprises at least one of air pressure of the tire, tire contact patch area and/or shape, contact forces acting on the tire, slippage, tread depth, and adhesion characteristics of the road.

5. The vehicle of claim 1, wherein the controller is configured to control a force exerted by the actuator or configured to control a length of the actuator.

6. The vehicle of claim 1, wherein the command parameter is a command force, a command torque, a command current, or a command position/length.

7. A method comprising:
affixing a smart tire assembly to a vehicle, wherein the smart tire assembly includes a tire and one or more sensors configured to sense a magnitude of one or more physical quantities;
installing an active suspension system into the vehicle, wherein the active suspension system includes an actuator and a controller configured to control the actuator; and
placing the controller of the active suspension system in communication with the one or more sensors of the smart tire assembly.

8. The method of claim 7, wherein the one or more sensors integrated with the tire are configured to generate an output that corresponds to the magnitude of the sensed one or more physical quantities, and wherein controller is configured to receive the output and to generate a command parameter based at least in part on the received output.

9. The method of claim 1, wherein the one or more physical quantities of the tire comprises at least one of air pressure of the tire, tire contact patch area and/or shape, contact forces acting on the tire, slippage, tread depth, and adhesion characteristics of the road.

10. The method of claim 1, wherein the controller is configured to control a force exerted by the actuator or configured to control a length of the actuator.

11. The method of claim 1, wherein the command parameter is a command force, a command torque, a command current, or a command position/length.

12. A method of operating a vehicle having a set of tires and an active suspension system, the method comprising:
operating the vehicle to travel along a road surface;
sensing, using a smart tire assembly, a magnitude of one or more physical quantities associated with at least one tire of the set of tires; and
controlling the active suspension system of the vehicle based at least in part on the magnitude of the sensed one or more physical quantities.

13. The method of claim 12, wherein the one or more physical quantities of the tire comprises at least one of air pressure of the tire, tire contact patch area and/or shape, contact forces acting on the tire, slippage, tread depth, and adhesion characteristics of the road.

14. The method of claim 12, wherein controlling the active suspension system comprises controlling a vertical force exerted by an actuator of the active suspension system.

15. The method of claim 14, wherein the actuator is a hydraulic actuator.

16. The method of claim 12, comprising:
generating, via one or more sensors integrated into the smart tire assembly, an output; and
receiving, by a controller of the active suspension system, the output.

17. The method of claim 16, wherein the output is an electrical voltage, an electric current, an optical signal, or an electromagnetic signal.

18. The method of claim 16, comprising:
determining, by the controller of the active suspension system, a command parameter based at least in part on the received output,
wherein the command parameter is a command force, a command torque, a command current, or a command position/length.

19. The method of claim 18, wherein the command parameter is a command force, the method further comprising: operating an actuator of the active suspension system to apply the command force to a body of the vehicle and/or a wheel or wheel assembly of the vehicle.

20. The method of claim 19, wherein operating the actuator to apply the command force comprises:
determining, based on the command force, a command torque; and
operating an electric motor to apply the command torque to a rotor of a pump of the actuator.
